(19) United States
(12) Patent Application Publication
(10) Pub. No.: US 2005/0109924 A1
(43) Pub. Date: May 26, 2005

(54) Apparatus for encoding and indexing

(76) Inventors: David Christenson, Clackamas, OR (US); Wen-Li Su, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/723,233

(22) Filed: Nov. 26, 2003

(51) Int. Cl. G01D 5/34

(52) U.S. Cl. 250/231.13

(57) ABSTRACT

A light source to emit light, and sensors to sense the light after passing through windows, are configured to perform encoding and indexing.

### BACKGROUND

An apparatus may make use of one or more moveable elements. It may be helpful to determine a current location of a moveable element during operation of such an apparatus. Encoding and indexing may be employed to assist in the determination of the current location of the moveable element. Improving either the encoding mechanism, the indexing mechanism, or both may contribute to reducing the cost of making the apparatus.

An example of such an apparatus is an imaging system. An example of a moveable element of an imaging system is a pen assembly of the imaging system.

### BRIEF DESCRIPTION OF THE DRAWINGS

Embodiments of the present invention will be described referencing the accompanying drawings in which like references denote similar elements, and in which:

FIGS. 1a-1c illustrate cross section views of an arrangement in accordance with different embodiments of the present invention;

FIGS. 2-3 illustrate a “top” exposed view of the code wheel, and a “side” isolated view of the light source of the embodiments in FIG. 1a-1c in further detail respectively;

FIG. 4 illustrates a cross section view of another arrangement in accordance with another embodiment of the present invention;

FIG. 5 illustrates a “top” exposed view of the code wheel of the embodiment in FIG. 4 in further detail;

FIGS. 6a-6c illustrate cross sections views of yet another arrangement in accordance with yet other embodiments of the present invention;

FIGS. 7a-7c together illustrate a “top” exposed view of each of two other code wheels in further detail;

FIGS. 8a-8b together illustrate a cross section view of yet another arrangement in accordance with another embodiment of the present invention;

FIGS. 9a-9b illustrate two signals output by the sensors of FIG. 8a-8b for the code wheel embodiments of FIG. 7b-7c respectively; and

FIG. 10 illustrates an example imaging system incorporated with the teachings of one embodiment of the present invention.

### DETAILED DESCRIPTION OF EMBODIMENTS OF THE INVENTION

Embodiments of the present invention include, but are not limited to a sensor for encoding and indexing, a companion code wheel, and arrangements and/or imaging systems endowed with these elements.

In the following description, various aspects of embodiments of the present invention will be described. However, it will be apparent to those skilled in the art that embodiments of the present invention may be practiced with only some or all aspects described. For purposes of explanation, specific numbers, materials and configurations are set forth in order to provide a thorough understanding of these embodiments of the present invention. However, it will be apparent to one skilled in the art that various embodiments of the present invention may be practiced without the specific details. In other instances, well-known features are omitted or simplified in order not to obscure the disclosed embodiments of the present invention.

The phrase “in one embodiment” is used repeatedly. The phrase generally does not refer to the same embodiment, however, it may. The terms “comprising”, “having” and “including” are synonymous, unless the context dictates otherwise.

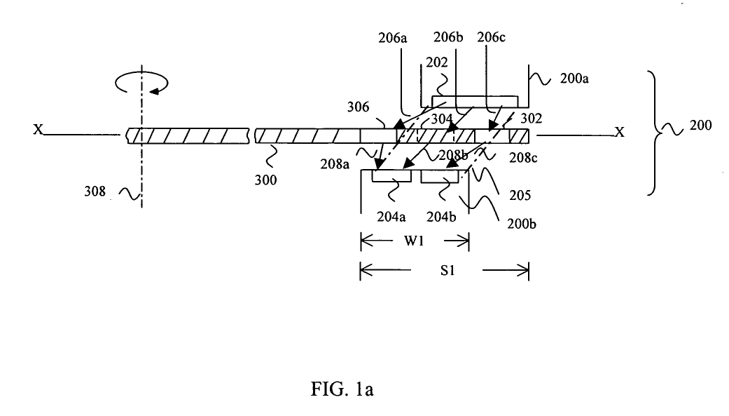

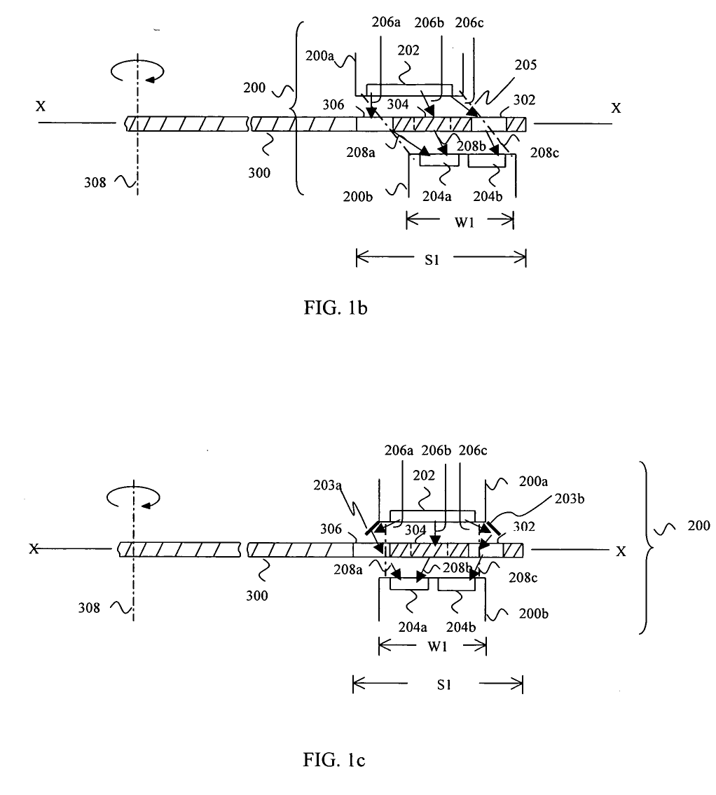

Referring now to FIGS. 1a-1c wherein cross sectional views of an arrangement, in accordance with different embodiments of the present invention are shown. As illustrated, the arrangement includes sensor assembly 200 and code wheel 300 for encoding and sensing. Axis 308 is the axis of a rotate-able shaft which current angular position is to be determined employing sensor assembly 200 and code wheel 300.

Sensor assembly 200 includes portion 200a and portion 200b. Portion 200a includes light source 202, while portion 200b includes sensors 204a and 204b. Light source 202 emits collimated light rays 206a-206c. In various embodiments, sensors 204a-204b are comprised of photocells.

However, portions 200a and 200b are offset and has a width (w1) that is smaller than span (s1) of encoder and index tracks 302-306.

Further, light source 202 does not emit collimated light rays 206a-206c orthogonally towards sensors 204a-204b. Instead, light source 202 emits collimated light rays 206a-206c angularly towards sensors 204a-204b.

As will be described in more detail below, for the embodiment, transparent windows of encoder track 302 and index tracks 304-306 are either formed with materials having appropriate complementary refraction indices or coated with materials to provide the transparent windows with the appropriate complementary refraction indices, such that when the transparent windows pass underneath light source 202, angularly emitted collimated light rays 206a-206c are refracted 208a-208c onto sensors 204a-204b, and thus, may be sensed by sensors 204a-204b. Further, the transparent windows of encoder track 302 and index tracks 304-306 may be of different shapes, including non-rectangular shapes.

For the embodiment of FIG. 1a, the “smaller” portions 200a-200b are “offset” in favor of encoder track 302. Accordingly, light source 202 emits all collimated light rays 206a-206c towards sensors 204a-204b with increasing deviation angles (relative to the orthogonal direction) from collimated light rays 206c to collimated light rays 206a. That is, relative to the orthogonal direction, collimated light rays 206b have larger deviation angles when compared to collimated light rays 206c, and collimated light rays 206a have larger deviation angles when compared to collimated light rays 206b and 206c.

In contrast, for the embodiment of FIG. 1b, the “smaller” portions 200a-200b are “offset” in favor of index track 306. Accordingly, light source 202 emits all collimated light rays 206a-206c towards sensors 204a-204b with increasing deviation angles (relative to the orthogonal direction) from collimated light rays 206a to collimated light rays 206c. That is, relative to the orthogonal direction, collimated light rays 206b have larger deviation angles when compared to collimated light rays 206a, and collimated light rays 206c have larger deviation angles when compared to collimated light rays 206a and 206b.

For the embodiment of FIG. 1c, portion 200a also includes mirrors 203a-203b. The “smaller” portions 200a-200b are substantially “centered” over index track 304. Accordingly, light source 202 emits collimated light rays 206b orthogonally towards sensors 204a. Collimated light rays 206a and 206c, on the other hand, are emitted angularly away from sensors 204a-204b (relative to the orthogonal direction), and reflected by mirrors 203a-203b to pass through transparent windows of index and encoder tracks 306 and 302 respectively. As before, collimated light rays 206a and 206c are then refracted onto sensors 204a and 204b.

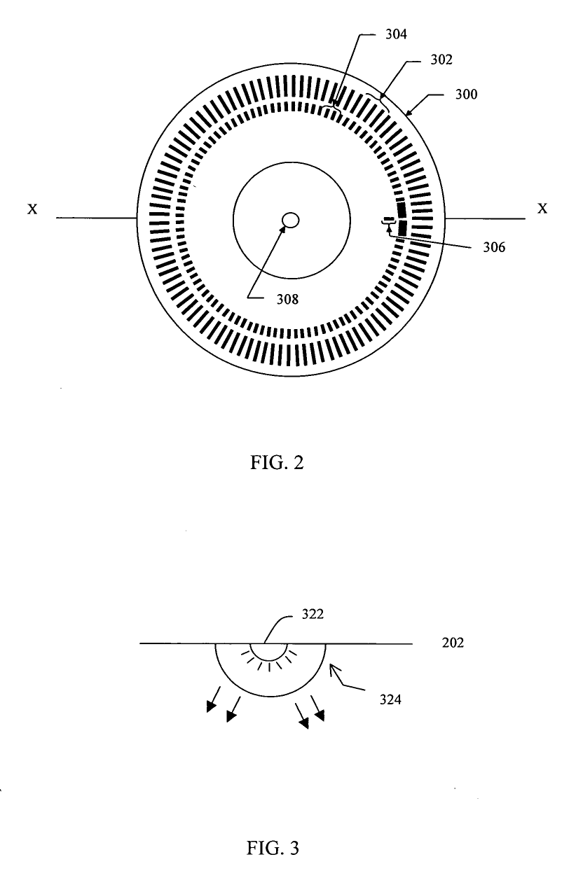

FIG. 2 illustrates code wheel 300 in further detail in accordance with one embodiment. Code wheel 300 includes encoder track 302, and index tracks 304-306, each having a number of transparent windows, except in the case of index track 306, a single transparent window. As described earlier, appropriate ones of the transparent windows (depending on the dispositions of the different portions of sensor assembly 200) are either advantageously formed or coated with materials that provide the transparent windows with the appropriate complementary refraction indices to refract collimated light rays 206a-206c emitted by light source 202 onto sensors 204a-204b. Further, the transparent windows may be of different and non-rectangular shapes.

The appropriate refraction indices depend on the relative positioning between the “smaller” sensor assembly 200 and the encoder and index tracks 302-306. Any one of a number of materials or combination of materials may be employed to provide the desired refraction indices.

FIG. 3 illustrates light source 202 in further detail, in accordance with one embodiment. As illustrated, light source 202 includes light emitting diode (LED) 322 and lens 324. Lens 324 include a number of portions, having different refraction indices, a first refraction index for a first portion, a second refraction index for a second portion, and so forth, to enable collimated light rays 206a-206c to be emitted with the desired angles of deviation.

In alternate embodiments, light source 202 may employ more than one LED.

Referring back to FIG. 1a-1c, thus a modulation signal, and in turn, an index pulse useable to assist the determination of a current location of a moveable element of an apparatus during operation, may be generated, but with the ability to employ a “smaller” sensor assembly 200. The ability to employ a “smaller” sensor assembly 200 contributes towards freeing up the otherwise occupied space for use by other components to provide additional functions, or contributes towards enabling smaller, more compact, and possibly less costly systems to be built.

While the embodiments of the FIG. 1a-1c have been described with selected ones of collimated light rays 206a-206c being emitted with deviation angles (relative to the orthogonal direction) towards sensors 204a-204b, and the emitted light rays being refracted onto sensors 204a-204b as the transparent windows of encoder and index tracks 302-306 pass “underneath” light source 202, alternate embodiments, may also be practiced with angularly emitted light rays 206a-206c passing through corresponding ones of transparent windows of encoder and index tracks 302-306 before or after they passed “underneath” light source 202. These embodiments may be practiced with emitted light rays 206a-206c not only having deviation angles in the plane where FIG. 1a-1c are illustrated, but also in another plane orthogonal or otherwise intersect with the plane of FIG. 1a-1c.

Further, as illustrated, portions 200a and 200b may be different portions of a single housing. That is, the single housing includes a common portion 205 joining portions 200a and 200b. In various embodiments, circuitry in support of modulating a signal based on the amount of light rays sensed by sensors 204a-204b and generating the index pulse when the modulated signal sensed by sensors 204a exceeds a threshold, may be disposed in common portion 205 joining portions 200a and 200b.

Additionally, the embodiments of FIG. 1a-1c have been described referencing code wheel 300 of FIG. 2 with the index tracks 304-306 being disposed “inside” of “outermost” encoder track 302. Alternate embodiments may also be practiced with other disposition arrangements, including but are not limited to having either or both index tracks 304-306 being disposed “outside” of encoder track 302, as well as having only one index track.

Further, while the embodiments of FIG. 1a-1c have been described referencing code wheel 300 of FIG. 2, code wheel 300 may also be referred to as a code sheet having a wheel like form factor with the earlier described tracks of transparent windows disposed thereon. Alternate embodiments may be practiced with code sheets of other form factor. In particular, alternate embodiments may be practiced with a code sheet having a linear form factor for assisting in determining a current location of a moveable element that moves linearly (as opposed to angularly, in the case of a shaft). Technically, a linear moving element can be considered as a special angular moving element, where the radius that defines the “orbit” of movement is “infinite” in length.

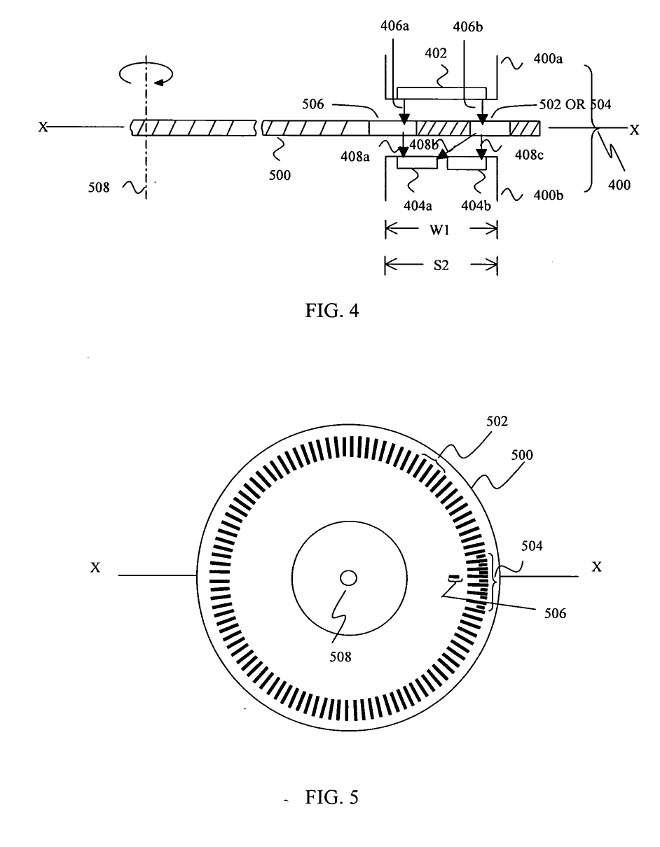

FIGS. 4 and 5 illustrate another embodiment of the present invention. Again, FIG. 4 illustrates a cross sectional view of an arrangement to assist in determining a current location of a moveable element of an apparatus. The arrangement includes sensor assembly 400 and code wheel 500. The arrangement is illustrated in the context of using sensor assembly 400 and code wheel 500 to determine a current angular position of a rotate-able shaft, which axis is depicted as axis 508 in FIG. 4-5.

Sensor assembly 400 includes two portions 400a and 400b, with portion 400a having light source 402 and portion 400b having sensors 404a-404b. Dimension wise, sensor assembly 400 is substantially that of the “smaller” embodiments of FIG. 1a-1c, i.e. having width (w1). However, sensor assembly 400 is employed with code wheel 500, where one of the index tracks, more specifically, index track 504 is a partial ring. Further, index track 504 is “merged” with encoder track 502. That is, the transparent windows of index track 504, in addition to being formed with or coated with materials, as appropriate, to refract collimated light rays 506b onto sensors 504a, the transparent windows of index track 504 are interleaved with a subset of the transparent windows of encoder track 502. Accordingly, for the embodiment, the span (s2) of encoder and index tracks 502-506 is substantially equal to the width (w1) of portions 500a and 500b.

For the embodiment, light source 402 is substantially “centered” over sensors 404a-404b. Thus, unlike the embodiments of FIG. 1a-1c, light source 402 emits light rays orthogonally towards sensors 404a-404b. Accordingly, only the transparent windows of index track 504 are formed or coated with materials to provide an appropriate refraction index. The transparent windows of encoder track 502 and index track 506 may be conventionally formed.

Nevertheless, because span s2 is smaller, for a given technology or process in making code wheel 500 with transparent windows of a particular dimension (precision), code wheel 500 is advantageously more compact (smaller) than code wheel 300. Accordingly, the overall dimension of the arrangement of FIG. 4 may be even smaller than the overall dimension of the arrangement of FIG. 2.

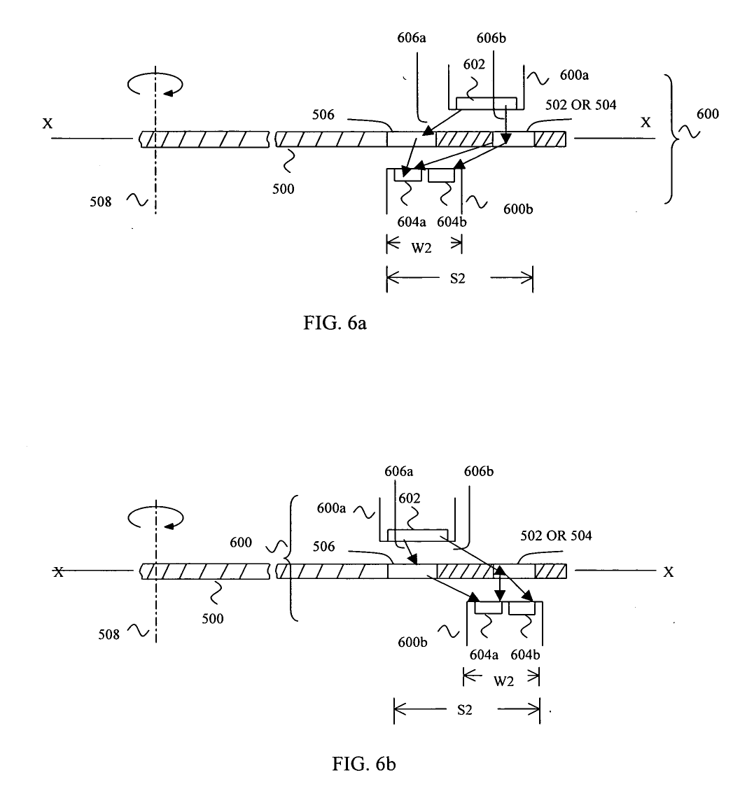

FIGS. 6a-6c illustrate yet other embodiments of the present invention. Again, FIG. 6a-6c illustrate cross sectional views of an arrangement to assist in determining a current location of a moveable element of an apparatus. The arrangement includes sensor assembly 600 and code wheel 500. Again, the arrangement is illustrated in the context of determining a current angular location of a rotate-able shaft, which axis is depicted as axis 508.

Similar to the embodiments of FIG. 1a-1c, sensor assembly 600 includes two offset portions 600a and 600b, with portion 600a having light source 602 and portion 600b having sensors 604a-604b. Similar to the embodiments of FIG. 1a-1c, light source 602 emits collimated light rays 606a-606b angularly deviated from the orthogonal direction. However, for these embodiments, light source 602 merely emits two bundles of collimated light rays 606a-606b with angular deviations. Also similar to the embodiments of FIG. 1a-1c, angularly emitted collimated light rays 606a-606b are refracted onto sensors 604a-604b for sensing, by the transparent windows of encoder and index tracks 502-506 with appropriate refraction indices. Thus, when used with sensor assembly 600 of FIG. 6a-6c, one or both of the transparent windows of encoder track 502 and index track 506 may also be formed or coated with materials to provide appropriate refraction indices (in addition to the transparent windows of index track 504).

Thus, sensor assembly 600 is essentially sensor assembly 200 further shrunk to the dimension of the width (w2) of a single track of code wheel 500. Accordingly, the embodiments of sensor assembly 600 may be as small as half of the dimension of sensor assemblies 200 and 400 of FIGS. 2 and 4 respectively, providing a very compact arrangement solution for determining a current location for a moveable element in an apparatus, during its operation.

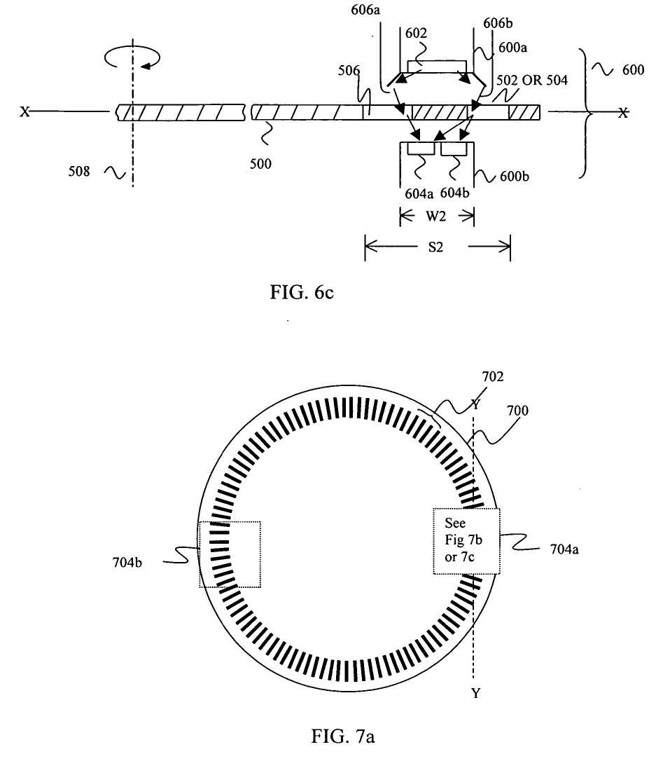

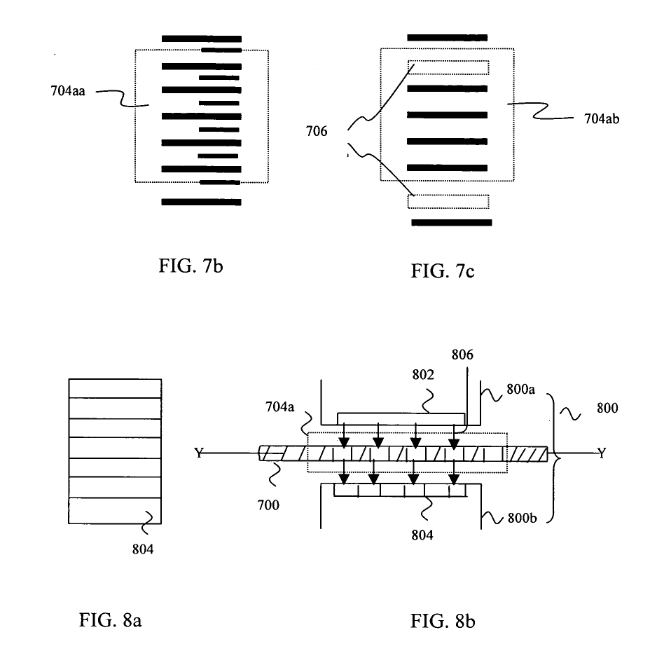

FIGS. 7a-7c together illustrate two embodiments of yet another code wheel 700. As illustrated, code wheel 700 includes only one track 702 of transparent windows that serve as an encoder track as well as an index track. The transparent windows of track 702 are non-uniformly distributed, in that while virtually all portions (e.g. portion 704b) of tracks 702 are approximately 50-50 balanced between transparent window areas and non-transparent areas (the areas not having transparent windows), portion 704a of track 702 is either configured to allow more lights to pass through, e.g. with more transparent windows (portion 704aa of FIG. 7b), or configured to allow less lights to pass through, e.g. with less transparent windows (portion 704ab of FIG. 7c). The areas enclosed by the dotted lines 706 in FIG. 7c depict the areas where transparent windows would have been provided in a uniformly distributed, 50-50 balanced configuration.

Note that in alternate embodiments, the transparent windows may have non-rectangular shapes. The transparent windows may also be simply openings.

FIGS. 8a-8b together illustrate a cross section view of code wheel 700 in conjunction with another sensor assembly 800. As illustrated in FIG. 8b, the cross sectional view of code wheel 700 and sensor assembly 800 is the cross section along the Y-Y axis depicted in FIG. 7a. As before, sensor assembly 800 includes two portions 800a and 800b. Portion 800a includes light source 802, whereas portion 800b includes a linear array of sensors 804 (see also FIG. 8a).

For the illustrated embodiment, sensors 804 are configured to sense lights for both encoding and indexing, without partitioning the sensors 804 into two groups, a group to sense light rays for encoding, and another group to sense light rays for indexing.

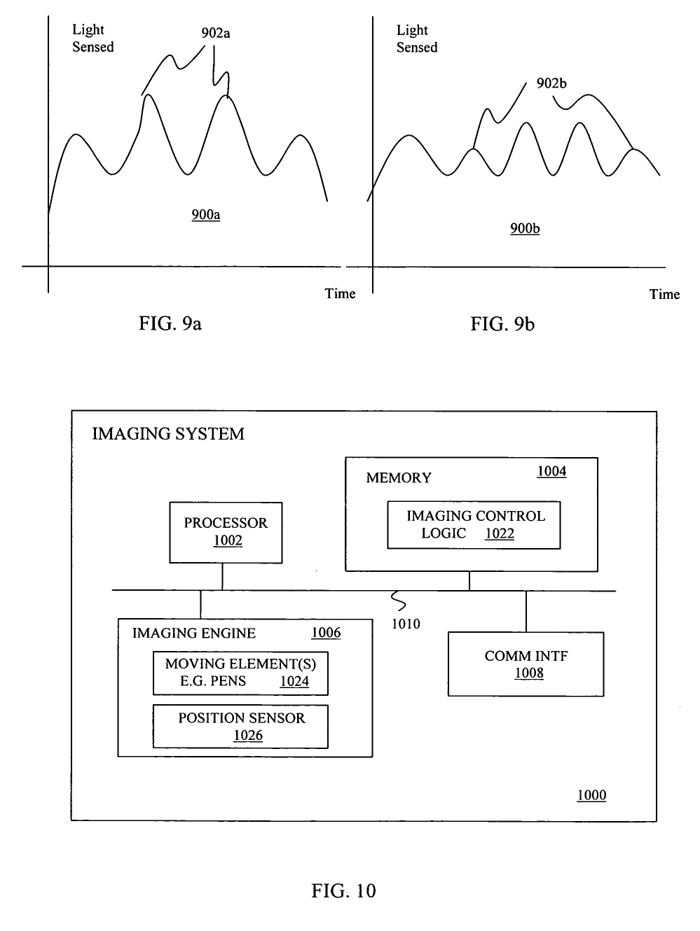

Light source 802 emits light rays 806 orthogonally towards sensors 804. Thus, the amount of light sensed by sensors 804, and the signals in turn output by sensors 804 are as illustrated by the signals 900a and 900b of FIG. 9a-9b (corresponding to the code wheel embodiments of FIG. 7b-7c respectively). As depicted, signal 900a reflects more light being sensed (peaks 902a) when portion 704aa passes underneath light source 802 (as compared to other portions of track 702), whereas signal 900b reflects less light being sensed (peaks 902b) when portion 704ab passes underneath light source 802 (as compared to other portions of track 702). [Note that signals 902a and 902b are not illustrated to any scale, and the number of peaks are merely exemplary for illustrative purpose only. In practice, the signals outputted by the sensors may be analog or digital signals.]

Thus, by virtue of the changes in the peaks of signals 900a-900b, the signals may in turn be processed (e.g. by software hosted by a controller or dedicated hardware (not shown)) to output corresponding derivative signals for encoding and indexing.

In alternate embodiments, sensors 804, in addition to being linearly arranged as shown in FIG. 8a, may be configured with the sensors disposed at the ends adapted to sense the light rays for indexing, while other sensors adapted to sense the light rays for encoding.

In other words, by virtue of a single optical diameter for both encoding and indexing, code wheel 700 may be further made smaller as compared to the earlier described embodiments.

FIG. 10 illustrates an example imaging system incorporated with at least some of the teachings of the earlier described embodiments of an arrangement for assisting in the determining of a current location of a moveable item. As illustrated, for the embodiment, imaging system 1000 includes processor/controller 1002, memory 1004, imaging engine 1006 and communication interface 1008 coupled to each other via bus 1010. Imaging engine 1006 comprises one or more moveable elements 1024, such as a pen assembly, and one or more corresponding position sensor arrangements 1026 to sense a current location of a corresponding one of the moveable elements 1024.

Memory 1004 is employed to store instructions and/or data, more specifically, imaging control logic 1022. Imaging control logic 1022 is employed to control imaging of images including sensing of the current locations of the various moveable elements 1024 at different points in time during operation, using position sensor arrangements 1026.

In alternate systems, application specific circuits (ASIC) may be employed in lieu processor/controller 1002 and memory 1004 having imaging control logic 1022.

Similarly, except for position sensor arrangement 1026, processors 1002, memory 1004, imaging engine 1006 (including moveable elements 1024), communication interface 1008, and bus 1010 all represent corresponding broad ranges of such elements.

Position sensor arrangement 1026 may be any one of the earlier described sensor arrangements. In various embodiments, position sensor arrangement 1026 is the arrangement of FIG. 8a-8b, using one of the code wheels of FIG. 7a-7c. For some of these embodiments, imaging control logic 1022 is further equipped to process the output signals of 900a/900b to generate corresponding signals for encoding and indexing. In other ones of these embodiments, dedicated hardware (not shown) is further provided to imaging system 1000 to process the output signals of 900a/900b to generate corresponding signals for encoding and indexing.

In various embodiments, imaging system 1000 may be an inkjet printer or an electrophotographic printer.

Thus, it can be seen from the above descriptions, embodiments of a novel arrangement to determine a current location of a moveable element of an apparatus has been described. While the novel method has been described in terms of the foregoing embodiments, those skilled in the art will recognize that the method is not limited to the embodiments described. The method may be practiced with modifications and alterations within the spirit and scope of the appended claims.

Thus, the description is to be regarded as illustrative instead of restrictive.

1. An apparatus comprising:
a light source to emit light to pass through a portion of a track of windows, with the portion of the track configured to allow a different amount of the light to pass through relative to other portions of the track; and
a plurality of sensors to sense the light for encoding and indexing.

2. The apparatus of claim 1, wherein the portion includes a configuration to allow more of the light to pass through relative to the other portions of the track.

3. The apparatus of claim 1, wherein the portion includes a configuration to allow less of the light to pass through relative to the other portions of the track.

4. The apparatus of claim 1, wherein each of the plurality of sensors is configured to sense the light for encoding as well as indexing.

5. The apparatus of claim 1, wherein the sensors are linearly configured with a first and a second of the plurality of sensors disposed at both ends, configured to sense the light for indexing, while others are configured to sense the light for encoding.

6. The apparatus of claim 1, wherein the apparatus further comprises a code wheel, on which the windows are disposed.

7. The apparatus of claim 1, wherein
each of the plurality of sensors is configured to sense the light for encoding as well as indexing, and the sensors output signals reflective of the amount of light the sensors sensed; and
the apparatus further comprises means to process the output signals and generate derivative signals based at least in part on the output signals for encoding and indexing respectively.

8. The apparatus of claim 1, wherein the sensors include photocells.

9. The apparatus of claim 1, wherein the windows include transparent windows.

10. A position sensing method comprising:
emitting light to pass through a portion of a track of windows, the portion configured to allow a different amount of the light to pass through relative to other portions of the track; and
sensing the light.

11. The method of claim 10, wherein the method further comprises the sensors outputting signals reflective of the amount of light the sensors sensed, and processing the output signals to generate a first and a second derivative signal based at least in part on the output signals for encoding and indexing respectively.

12. An imaging system
a communication interface to receive data of an image; and
an imaging engine coupled to the communication interface to form the image, including a moveable element and a position sensing assembly to sense a current location of the moveable element, the position sensing assembly having a code sheet and a combined encoder and index sensor arrangement, the code sheet having a track of non-uniformly distributed windows.

13. The imaging system of claim 12, wherein the track of non-uniformly distributed windows includes a number of portions with a portion configured to allow more light to pass through than other like portions.

14. The imaging system of claim 12, wherein the track of non-uniformly distributed windows includes a number of portions, with a portion configured to allow less light to pass through than other like portions.

15. The imaging system of claim 12, wherein the combined encode and index sensor arrangement includes a plurality of sensors to sense light passed through the windows concurrently for encoding and indexing.

16. The imaging system of claim 15, wherein the sensors include photocells.

17. The imaging system of claim 12, wherein the combined encode and index sensor arrangement includes a plurality of linearly configured sensors with a first and a second of the sensors disposed at the respective ends to sense light passed through the windows for indexing, and the rest of the sensors to sense light passed through the windows for encoding.

18. The imaging system of claim 12, the windows include transparent windows.

19. An apparatus comprising:
a first and a second plurality of sensors; and
a light source to emit light in two or more directions, with one of the two or more directions being an angular direction, and the light to be sensed by the first and the second plurality of sensors after passing through a first window of an encoder track, and a second window of an index track respectively, with either the first window, the second window or both refracting the passing light.

20. The apparatus of claim 19, wherein the light emitted to pass the first window of the encoder track is emitted in an angular direction.

21. The apparatus of claim 19, wherein the light emitted to pass the second window of the index track is emitted in an angular direction.

22. The apparatus of claim 19, wherein the light source includes a lens having two areas with two different refraction indices to facilitate emission of light in the two directions.

23. A code sheet comprising
a medium;
an encoder track of first windows disposed on the medium;
an index track of second windows disposed on the medium; and
a selected one of the first windows and the second windows have a refractive index suitable to refract light in a predetermined angle.

24. The code sheet of claim 23, wherein the first windows have a refractive index suitable for refracting the light in the predetermined angle.

25. The code sheet of claim 23, wherein the second windows have a refractive index suitable for refracting lights in the predetermined angle.

26. The code sheet of claim 23, wherein the second windows interleave with some of the first windows.

27. The code sheet of claim 23, wherein the medium has a selected one of a wheel form factor and a linear form factor.

28. A position sensing method comprising:
emitting light in a first direction and a second direction, one of which being an angular direction, for sensing by a first and a second plurality of sensors after passing first windows of an encoder track and second windows of an index track respectively, with either the first windows, the second windows or both refracting the passing light; and
sensing the light employing the first and second plurality of sensors.

29. The method of claim 28, wherein said emitting of light in two directions comprises emitting lights angularly to be refracted by selected ones of the windows of the encoder track.

30. The method of claim 28, wherein said emitting of light in two directions comprises emitting light angularly to be refracted by a selected one of the windows of the index track.

31. An imaging system
a communication interface to receive data of an image to be formed; and
an imaging engine coupled to the communication interface to form the image, including a moveable element and a position sensing assembly to sense a current location of the moveable element, the position sensing assembly having a code sheet and a combined encoder and index sensor arrangement for sensing of the current location of the moveable element employing angular emission of light, refraction and sensing of the light.

32. The imaging system of claim 31, wherein the combined encoder and index sensor arrangement comprises
a first and a second plurality of sensors; and
a light source to emit light in two directions, with one of the two directions being an angular direction.

33. The imaging system of claim 32, wherein the light source emits light in an angular direction towards windows of an encoder track for passing onto a number of sensors of the combined encoder and index sensor arrangement.

34. The imaging system of claim 32, wherein the light source emits light in an angular direction towards windows of an index track for passing onto a number of sensors of the combined encoder and index sensor arrangement.

35. The imaging system of claim 32, wherein the code sheet comprises
a medium;
an encoder track of first windows disposed on the medium, the first windows having a first refractive index; and
an index track of second windows disposed on the medium, the second windows having a second refractive index.

36. The imaging system of claim 35, wherein the windows of the index track interleave with some of the windows of the encoder track.

37. The imaging system of claim 35, wherein the medium has a selected one of a wheel form factor and a linear form factor.

38. An apparatus comprising:
first means to sense emitted light; and
second means to emit light in two directions, with one of the two directions being an angular direction, to be sensed by the first means after passing a first window of an encoder track and a second window of an index track respectively, with either the first window, the second window or both refracting the passing light.

39. The apparatus of claim 38, wherein the apparatus further comprises a code wheel, on which the encoder and index tracks are disposed.
